(19) United States
(12) Patent Application Publication
(10) Pub. No.: US 2012/0012186 A1
(43) Pub. Date: Jan. 19, 2012

(54) EVAPORATION CHAMBER, INTERMEDIATE CHAMBER, AND METHOD

(75) Inventors: Malinda Tantra, Hamburg (DE); Martin Baecke, Dessau (DE)

(73) Assignee: seleon GmbH, Dessau (DE)

(21) Appl. No.: 13/221,194

(22) Filed: Aug. 30, 2011

Related U.S. Application Data
(63) Continuation of application No. PCT/DE2010/075020, filed on Mar. 2, 2010.

(30) Foreign Application Priority Data
Mar. 3, 2009 (DE) 10 2009 011 137.9

(51) Int. Cl. F24F 6/02; F17D 1/00; B01F 3/04

(52) U.S. Cl. 137/1; 261/66; 261/70

(57) ABSTRACT

An evaporation chamber comprises a trough and an intermediate chamber disposed above the trough. The bottom of the intermediate chamber includes a liquid outlet through which liquid flows from the intermediate chamber into the trough. The intermediate chamber comprises a level valve, which allows a flow of liquid to follow from a liquid connection into the intermediate chamber so that the liquid level in the intermediate chamber is between a minimum level and a maximum level. The intermediate chamber has a liquid connection, a level valve, and a compensation connection. The liquid connection supplies a liquid. The level valve, allows a flow of liquid to follow from the liquid connection into the intermediate chamber so that the liquid level in the intermediate chamber is between a minimum level and a maximum level. The compensation connection is pneumatically connected to the gas space around the float.

This application claims priority from and is a continuation of PCT/DE2010/075020 entitled EVAPORATION CHAMBER, INTERMEDIATE CHAMBER, AND METHOD filed Mar. 2, 2010, by same inventors TANTRA, Malinda and BAEKE, Martin which is a continuation of German national application DE 10 2009 011 137.9 filed Mar. 3, 2009, the disclosures of which are incorporated herein by reference.

### FIELD OF THE INVENTION

The field of the invention relates to evaporation chambers, intermediate chambers and methods of the type defined in the preambles of patent claims 1, 3, 9 and 11.

The invention relates to the field of evaporators, specifically of respiratory humidifiers for nasal cannulae.

### DISCUSSION OF RELATED ART

The prior art describes a number of respiratory humidifiers for respirators which, in the broader sense, also include CPAP apparatus. CPAP stands for continuous positive airway pressure. In this connection the patent family DE 101 51 397 C1 (Attorney's file: HEP13), WO 03/035157 A1 and US 2004/0221843 A1 shall be cited as an example. These documents contain a more detailed explanation of the CPAP therapy as well as evaluations of other known respiratory humidifiers. This patent family describes respiratory humidifiers in which, at the height of the lower edge of a storage tank, a thin liquid layer is produced next to the storage tank above a heater. The respiratory air to be humidified is passed over the liquid layer. The advantage of this construction is, in particular, the quick operational readiness. To this end it is merely required to bring the liquid layer, the heater as well as a part of the casing in the proximity of the heater to the operating temperature. Specifically, it is not necessary to bring the total water reserve located in the storage tank to the operating temperature. Also, the power consumption is lower during the operation because only a small part of the casing, in the proximity of the heater, and not the whole storage tank has to be maintained at the operating temperature. Finally, it is an advantage that the filling level in the storage tank has practically no influence on the respiratory air as it travels through the respiratory humidifier. Specifically, the thickness of the liquid layer does not depend on the filling level in the storage tank. The operating mode of this humidifier may be called bird bath principle.

A respiratory gas humidifying device for CPAP apparatus is described in DE 199 36 499 A1. The humidifying device comprises a refill unit formed of a trough element and a pot part coupled therewith, which refill unit can be removed from a mountable casing. The trough element and the pot part are connected with each other tightly. A storage space for a liquid is formed in said pot part by means of a partition wall, which contains the major part of the water reserve provided for humidifying the respiratory gas. A separate humidifying region is formed in the trough element, which is disposed underneath the pot part, which region merely contains a small portion of the water reserve. The height of the water in the trough element is maintained at a predetermined level by a quantitative control conduit device, the level being defined by the lower edge of the quantitative control conduit device. Water continues to flow through a fluid conduit device from the liquid storage space into the trough element. If the water level in the trough element is too low, the quantitative control conduit device connects the air space above the water in the trough element to the air space above the water in the liquid storage space so that water continues to flow into the trough element. In use, the lower edge of the fluid conduit device is lower than the lower edge of the quantitative control conduit device. If the set water level in the trough element is reached, the water closes the lower opening of the quantitative control conduit device so that no water continues to flow in. Via a respiratory gas inlet opening the respiratory gas is blown through the upper portion of the trough element to a respiratory gas outlet opening. The bottom area of the trough element is heated by a heating device. For increasing the thermal transmission, the bottom area of the trough element is made of a material having a high thermal conductivity, e.g. metal.

A further development of the construction known from DE 101 51 397 C1 (HEP13) is described in DE 20 2004 004 115 U1 (Attorney's file: SEP27). To refill the air humidifier described in this document with water it is removed from a CPAP apparatus as a whole. The water is refilled through the air outlet opening. To this end, the air humidifier need not be disassembled any further.

An evaporator for CPAP apparatus is described in the patent family DE 101 63 800 A1 (Attorney's file: HEP9), WO 03/055555 A1 and US 2004/0261951 A1. In this evaporator a regulating reservoir is provided underneath a storage tank for a liquid, which regulating reservoir is connected to the storage tank by a control valve. The control valve preferably operates as a float and closes a valve opening if the liquid level in the regulating reservoir is high enough. A vertical heating channel communicates with the regulating reservoir. In a heating zone in the heating channel a resistance heating heats the uppermost liquid layer standing in the heating channel up to evaporation. The vapor rises upwardly through the vapor channel and is distributed by a vapor nozzle in the air intake flange. Due to the control valve the handling and operating mode of the evaporator is similar to that of a coffee maker.

Moreover, nasal oxygen cannulae for the oxygen treatment are known from the prior art. The nasal oxygen cannula administers air at an increased oxygen partial pressure (>210 mbar) or pure oxygen into the patient's nose. An oxygen treatment is used, for instance, in the case of an acute or chronic hypoxemia resulting from respiratory or cardiovascular disorders (myocardial infarction, shock) or certain poisonings, e.g. with carbon monoxide, carbon dioxide, coal gas or smoke.

The use of nasal oxygen cannulae in an anti-snoring device is known from the patent family DE 10105383 C2 (Attorney's file: GEP1), WO 02/062413 A2 and U.S. Pat. No. 7,080,645 B2. This is also referred to as transnasal insufflation (TNI®). In this context, nasal oxygen cannulae are called nasal cannulae. Similar to the CPAP therapy a nasal cannula increases the pressure in the respiratory tract of the patient by a few mbar with respect to the ambient air pressure so as to afford a pneumatic splinting. In contrast to CPAP apparatus, the thin tubes of nasal cannulae require a blower to generate a substantially higher pressure in the range of 100 mbar at the inlet connection of the nasal cannula.

An evaporator for nasal cannulae is described in the patent family DE 10 2004 037 698 A1 (Attorney's file: SE31P), WO 2006/012877 A1 and U.S. Ser. No. 11/573,058. The evaporator is designed for the homecare use, i.e. it is supplied with ambient air and operated for 8 hours a night at most.

At present, only one single, purely mechanical autofeed mechanism is used for respiratory apparatus for hospitals, namely the float principle. It is cost-efficient, easy to mount, may be produced from bio-compatible material and does not permit any substantial deviations of the filling level. Other known methods have not been able to gain acceptance for this application owing to the strict regulations, especially the Medicinal Products Act (Medizinproduktgesetz—MPG), the Ordinance of Medical Devices Vigilance (Medizinprodukt-Sicherheitsplanverordnung—MPSV) and the Medical Devices Operator Ordinance (Medizinprodukt-Betreiberverordnung—MPBetreibV), and owing to costs, service life, exchangeability, cleaning or sterilisability of the components, maintenance, installation work and measurement position.

One example for the use of the autofeed mechanism in a humidifier chamber of a respiratory device is the humidifier chamber MR 290 of Fisher & Paykel with a float. This humidifier chamber is connected between the respiratory device and the patient. It consists of four important components: a float, a gas inlet and gas outlet aperture and a conduit for the water supply from a sterilized water container. The dry respiratory gas is conducted by the respiratory device into the humidifier chamber before the humidified respiratory gas is administered to a patient. The respiratory gas flows across the water heated by a heating plate in the humidifier chamber. The required respiratory gas humidity can be adjusted by the water temperature, which may be varied manually. A variation of the water temperature also induces a variation of the temperature of the respiratory gas. By means of a needle valve, which is actuated by the float, the aperture of the conduit for the water supply is closed when a set water level is reached. During the operation the water in the storage tank is reduced due to the water molecules carried off in the respiratory gas stream. The float sinks with the reduction of the water level so that the needle valve opens the conduit, allowing a flow of water to follow through the conduit into the storage tank. Thus, the water filling level in the humidifier chamber is kept nearly constant. The disadvantage is that the relatively large floats cover a considerable portion of the water surface and, moreover, require a certain immersion depth.

### SUMMARY OF THE INVENTION

The present invention relates to an evaporation chamber (2), comprising a trough (7) and an intermediate chamber (10) which, in use, is disposed above the trough. The bottom of the intermediate chamber includes a liquid outlet (14) through which liquid (25) flows from the intermediate chamber into the trough (7). The intermediate chamber (10) comprises a level valve (17, 20) which allows a flow of liquid to follow from a liquid connection (18) into the intermediate chamber so that the liquid level in the intermediate chamber (10) is between a minimum level and a maximum level. The present invention further relates to an intermediate chamber (2, 10), comprising a liquid connection (18), a level valve (17, 20) and a compensation connection (19). A liquid is supplied by the liquid connection (18). The level valve (17, 20) allows a flow of liquid to follow from the liquid connection (18) into the intermediate chamber (10) so that the liquid level in the intermediate chamber (10) is between a minimum level and a maximum level. The compensation connection (19) is pneumatically connected to the gas space around the float (20). The invention further relates to corresponding methods.

It is the object of the invention to provide an improved respiratory gas humidifier.

This object is achieved with the teaching of the independent claims.

Preferred embodiments of the invention are defined in the dependent claims.

The advantage of an evaporation chamber with an intermediate chamber, which comprises a level valve permitting, in use, the continued flow of liquid from a liquid connection into the intermediate chamber, so that the liquid level in the intermediate chamber is between a minimum level and a maximum level, is that the evaporation chamber may also be supplied by sterilized water containers which can even be mounted considerably higher than the evaporation chamber. Moreover, the float does not partially cover the water surface humidifying the air. Thus, a substantially larger water surface is available for the contact with the air, without increasing the surface area of the water container. By this, a higher humidifying capacity can be achieved. Furthermore, the water film may be kept thinner, so that shorter heating periods are possible and the system control can be accelerated.

If a compensating conduit is provided between the evaporation chamber and the sterilized water container, which can be connected to a compensation connection at the evaporation chamber, the evaporation chamber can even be operated at a considerable excess pressure as compared to the ambient pressure. This is necessary, for instance, for TNI®.

A level valve can be realized in an easy and cost-efficient manner, for instance, with a valve actuated by a float.

The humidification of gas in the space between a trough and the bottom of an intermediate chamber is advantageous because the surface of a water film standing in the trough is not reduced by a float. Moreover, the water film in the trough may be thinner as compared to the height of the set water level in the intermediate chamber because the water film need not produce a buoyancy for a float.

By using a compensating pipe in addition to a liquid outlet the continued flow of water and the pressure compensation are locally separated, so that the thickness of the water film in the trough is maintained more exactly.

By the guidance of the float by the compensating pipe the compensating pipe can advantageously assume an additional function. This simplifies the assembly and the disinfection of the intermediate chamber because the intermediate chamber need not comprise any additional guiding means and, therefore, has altogether fewer edges and a smaller surface area. In addition, the float is not disturbed by rising air bubbles.

Due to the fact that the upper surface of the float is inclined downwards in the outward direction it is avoided in a surprisingly simple manner that water accumulates on the float.

### BRIEF DESCRIPTION OF THE DRAWINGS

Preferred embodiments of the invention will be explained in more detail below with reference to the attached drawing. In the drawing:

FIG. 1 shows a respiratory gas humidifier according to the invention.

### LIST OF REFERENCE NUMBERS

1 respiratory gas humidifier
2 evaporation chamber
3 gas inlet
4 gas outlet
5 lid
6 heating plate
7 trough
8 water film
9 air flow
10 intermediate chamber
11 compensating pipe
12 upper end
13 lower end
14 water outlet
15 lower end
16 guide
17 needle valve
18 water connection
19 compensation connection
20 float
21 recess
22 upper side
23 lower side
24 evaporation space
25 water
26 casing
31 water conduit
32 roller clamp
33 sterilized water container
34 water
35 compensating conduit

### DETAILED DESCRIPTION OF THE PREFERRED EMBODIMENTS

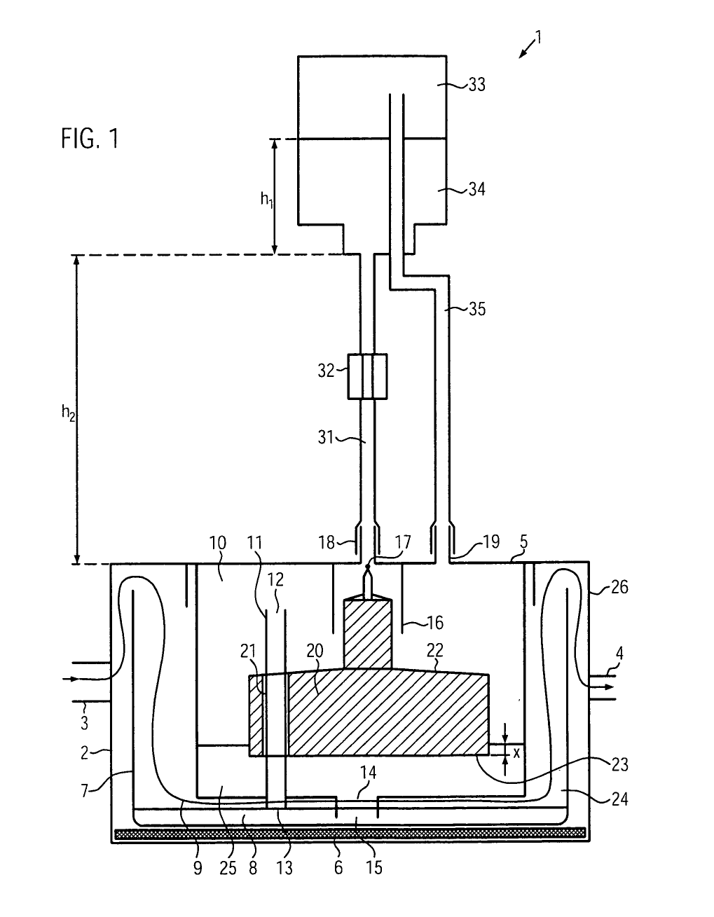

The respiratory gas humidifier 1 according to the invention shown in FIG. 1 is substantially comprised of an evaporation chamber 2 and of a sterilized water container 33 which is connected by a water conduit 31 and a compensating conduit 35 to a water connection 18 and a compensation connection 19 of the evaporation chamber 2. The water conduit 31 is typically formed of a flexible, transparent plastic tube and can be closed by a roller clamp 32.

The evaporation chamber 2 comprises a casing 26, a lid 5, a heating plate 6, a trough 7 as well as an intermediate chamber 10. In FIG. 1, the casing 26 forms a gas inlet 3 on the left and a gas outlet 4 on the right. The air flow 9 from the gas inlet 3 to the gas outlet 4 across a water film 8 is drawn in as well. At its bottom the intermediate chamber 10 is provided with a water outlet 14 having a lower end 15. Moreover, a compensating pipe 11 is mounted on the bottom of the intermediate chamber 10 perpendicular to the bottom, i.e. vertically, so that, in use, respiratory gas can flow through the compensating pipe 11 into the interior of the intermediate chamber 10. The compensating pipe 11 has an upper end 12 and a lower end 13. The water connection 18 as well as the compensation connection 19 lead into the interior of the intermediate chamber 10. The water connection 18 may be closed or opened by a needle valve 17. The needle valve 17 is actuated by a float 20. The float 20 is guided at its upper portion by a guide 16 and by the compensating pipe 11 on the left. The compensating pipe 11 runs through a recess 21 in the float 20. The upper side 22 of the float 20 is inclined downwards from the center of the float 20, which is located underneath the needle valve 17, in an outward direction at an angle of 10° so as to prevent water drops or even water puddles from accumulating on the upper side of the float. The intermediate chamber may be produced from a hard plastic material.

In use, water flows from the sterilized water container 33 through the water conduit 31 into the intermediate chamber 10 and is herein designated with reference number 25. If the water level in the intermediate chamber 10 is high enough the float 20 produces sufficient buoyancy so as to close the needle valve 17. This permits an approximately constant water level in the intermediate chamber 10.

A part of the water 25 flows through the water outlet 14 into the trough 7, where it forms the water film 8. The space above the water film 8 in the trough 7 is called evaporation space 24. The respiratory gas forced away by the water flowing into the trough 7 flows through the compensating pipe 11 into the intermediate chamber 10 until the water film 8 is thick enough to close the lower end of the compensating pipe 11. As a consequence, water continues to flow again from the intermediate chamber 11 into the trough 7 when the water film 8 has become thinner as a result of the evaporation and unblocks again the lower end 13 of the compensating pipe 11. As was mentioned above, this thickness control of the water film 8 can also be referred to as a bird bath principle.

A set value for the thickness of the water film 8 is approximately 7 mm, a minimum value is 5 mm and a maximum value is 15 mm. This value depends on the expansion of the water film 8, i.e. on the dimensions of the trough 7. If the device has an inclination of 15°, the inclination of the device should not reduce the interface between the air and the water film, if possible. This means that the entire bottom of the trough 7 should still be covered with water, and the water film should not yet touch the lower side of the intermediate chamber. Therefore, the thickness of the water film should be at most half the distance between the lower side of the intermediate chamber 10 and the upper side of the bottom of the trough 7. That is, if the thickness of the water film is 7 mm, the lower end 13 of the compensating pipe 11 has to project out of the bottom of the intermediate chamber 10 in the downward direction by at least 7 mm. The water outlet 14 has to be slightly longer, i.e. for instance 10 mm.

The water film 8 and the trough 7 are heated by a heating plate 6 which is located at the bottom of the casing 26. The humidity of the respiratory gas can be controlled in a manner known per se by the temperature of the water film 8, and thus by the temperatures of the heating plate 6 or the heating capacity supplied to the heating plate 6.

The pressures mentioned below are to be understood as positive pressure as compared to the ambient air pressure. For TNI® a pressure of 0 to 100 mbar is necessary so as to generate a sufficient air flow in the thin tubes of a nasal cannula. These up to 100 mbar are prevailing in the evaporation space 24. Therefore, a pressure-tight configuration is required for the lid 5 relative to the casing 26, for the connection of the water conduit 31 to the water connection 18 and to the sterilized water container 33, as well as for the connection of the compensating conduit 35 to the compensation connection 19 and to the sterilized water container 33. With respect to the pressure tightness three regions are distinguished:

1. the region flown through by air, i.e. basically the evaporation chamber 2:
The sealing thereof relative to the lid 5 and other components may be untight to an extent of less than 5% of the set air flow rate.
   2. the water-carrying region, i.e. the sterilized water container 33 along with water conduit 31, compensating conduit 35 and intermediate chamber 10:
The sealing of these components relative to each other may be untight only to a maximum extent of 5 ml of water/24 h at a positive pressure of 150 mbar relative to the ambient pressure, or 50 ml of air/24 h at a positive pressure of 100 mbar relative to the ambient pressure.
   3. the needle valve 17:
The needle valve 17 may be untight by not more than 50 ml of water/24 h at 10 mbar caused by the water column above the needle valve 17.

The requirements with respect to the tightness serve to avoid the drenching of the surroundings and the flooding of the respiratory gas path with water.

Both bottles and bags may be used as containers 33 for the sterilized water. Bags are inflated through the compensating conduit 35. If the height h₃, i.e. the height difference between the surface of the water film 8 and the water level in the intermediate chamber 10, is 1.5 cm, the pressure in the intermediate chamber 10 above the water 25 is lower by 1.5 mbar than the pressure in the evaporation space 24, which may usually be neglected. The pressure in the intermediate chamber 10 above the water 25 is transferred through the compensating conduit 35 into the sterilized water container 33. The pressure which the needle valve 17 has to close results from the height of the water column above the needle valve 17, which is (h₂+h₁) in FIG. 1. The sterilized water container 33 is frequently disposed 1.5 m above the needle valve 17, and the filling level in the sterilized water container 33 fluctuates between 0 and 20 cm so that the needle valve has to close a pressure of 150 to 170 mbar. This results in a certain range for the force required for the closure, thus for the buoyancy acting on the float, and thus for the water level in the intermediate chamber 10, respectively. The respective value depends in particular on the filling level in the sterilized water container, i.e. on h₁, but also h₂. These ranges become even greater if one considers that there is a friction in the needle valve 17, between the float 20 and the guide 16 as well as between the recess 21 and the compensating conduit 11. In each case, the water level in the intermediate chamber 10 has a maximum level and a minimum level. Between the maximum level and the minimum level an optional desired level can be defined, which can be, for instance, the arithmetic mean of maximum level and minimum level.

The water conduit 31 can be closed by means of a roller clamp 32 so that, if the lid 5 is opened, no water 34 escapes from the water conduit 31.

In another embodiment the compensating conduit 11 is not provided. In this embodiment, respiratory gas bubbles travel through the water outlet 14 into the intermediate chamber 10. In this embodiment, also the lower side 23 of the float will advantageously rise from the center of the float 20 outwardly, for instance, by 10° in order to prevent respiratory gas bubbles from accumulating underneath the float.

In one embodiment the maximum dimensions of the float are in mm:

width: 56, length: 94, height: 34; this results in a maximum float volume of 236880 mm³.

The required immersion depth x based on the use of the maximum width and length of the float, depending on the weight of the float m, is shown in the table below. A safety factor of 1.3 was used for the calculation:

| m/g | x/mm |
|---|---|
| 15 | 10 |
| 20 | 12 |
| 25 | 13 |
| 30 | 14 |
| 35 | 15 |
| 40 | 17 |

Moreover, there are some critical dimensions which pertain, above all, to the diameters of the tubes and pipes:

The inner diameter of the water conduit 31 and the compensating conduit 33 should not be smaller than 2.3 mm as capillary tensions would otherwise limit the motion of the water columns. It is advantageous if the water conduit 31 has an inner diameter of greater than 4 mm, ideally 6 mm, as possibly present air bubbles can then easily rise and do not obstruct the flow of water.

For the same reason the inner diameter of the compensating pipe 11 should be about 6 mm, however, not less than 4 mm.

If no compensating pipe 11 is provided, the water outlet 14 should have a minimum inner diameter of 15 mm, optimally about 20 mm.

The intermediate chamber 10 and the float 20 may be realized as disposables, so that only the casing 26 and the lid 5 need cleaning or disinfection.

In contrast to the evaporator known from WO2006/012887 A1 (Attorney's file: SE31P) the embodiments described in this document are intended for the use in hospitals, whereby air or oxygen is supplied from the central gas supply, and the use may take place 24 hours per day. Due to the clearly drier gas in the hospital the specific water consumption increases on an hourly basis. A filling more than once a day cannot be expected from the hospital staff. Thus, the required water supply increases from about 250 ml-300 ml in a home care case to 3 l in a clinical care case. This amount of water cannot be accommodated in the device. The delivery in a 3 l bag is typical, partly also in a canister/tank.

Although water had been mentioned so far, the respiratory gas humidifier according to the invention can also be used for the evaporation of other liquids such as essential oils. Although respiratory gas had been mentioned so far, which is usually air, also any other gases may be enriched with liquid molecules.

The water connection 18 and the compensation connection 19 may, in fact, be designed as separable connections. In another embodiment the water conduit 31 and the compensating conduit 35 may be connected to the intermediate chamber 10 permanently, so that the water connection 18 and the compensation connection 19 designate only the transition region between the conduits and the intermediate chamber.

Instead of the needle valve 17 any other valve may be used, e.g. with a flat seat. The invention was explained in more detail above by means of preferred embodiments. A person skilled in the art will appreciate, however, that various alterations and modifications may be made without departing from the spirit of the invention. Therefore, the scope of protection will be defined by the following claims and their equivalents.

1. An evaporation chamber comprising:
a trough; and
an intermediate chamber which when in use is disposed above the trough, wherein a bottom of the intermediate chamber includes a liquid outlet arranged to allow liquid to flow, when in use, from the intermediate chamber through the liquid outlet into the trough,
wherein the intermediate chamber comprises a level valve configured to allow a flow of liquid to flow from a liquid connection into the intermediate chamber so that the liquid level in the intermediate chamber is between a minimum level and a maximum level.

2. The evaporation chamber of claim 1, wherein the intermediate chamber further comprises a compensation connection pneumatically connected to a gas space around a float.

3. The evaporation chamber of claim 1, wherein the intermediate chamber further comprises:
a liquid connection for liquid supply; and
wherein the level valve is configured to allow a flow of liquid to flow from the liquid connection into the intermediate chamber so that the liquid level in the intermediate chamber is between a minimum level and a maximum level;
wherein a compensation connection is pneumatically connected to a gas space around the float.

4. The evaporation chamber of claim 1, wherein the level valve comprises:
a float floating on the liquid which has flown into the intermediate chamber; and
a valve is connected to the liquid connection so as to be able to open and close the liquid connection, wherein the valve is mechanically connected to the float such that the float closes the valve when the liquid level in the intermediate chamber has exceeded the maximum level, and the float opens the valve when the liquid level in the intermediate chamber is lower than the minimum level.

5. The evaporation chamber of claim 1, wherein the evaporation chamber further includes a trough underneath the intermediate chamber, wherein a bottom of the intermediate chamber includes a liquid outlet configured to allow liquid to flow, in use, from the intermediate chamber through the liquid outlet into the trough.

6. The evaporation chamber of claim 5, wherein the intermediate chamber further to comprises a compensating pipe whose lower end is situated, in use, underneath the bottom of the intermediate chamber and above the lower edge of the liquid outlet, wherein the upper end of the compensating pipe is situated, in use, above the upper edge of the liquid outlet.

7. The evaporation chamber of claim 6, wherein an upper end of the compensating pipe is located above the float, wherein the compensating pipe is arranged vertically, wherein the float comprises a recess through which the compensating pipe runs.

8. The evaporation chamber of claim 6, wherein the upper side of the float is inclined downwards from the center of the float underneath the valve in an outward direction.

9. A method for evaporating a liquid, comprising the steps of:
forming a liquid film in a trough; and
allowing a flow of liquid to follow from an intermediate chamber into the trough through a liquid outlet in the bottom of the intermediate chamber, so that evaporated liquid is replaced and the thickness of the liquid film remains approximately constant;
allowing a flow of liquid to follow from a liquid container through a level valve, into the intermediate chamber, wherein the level valve controls the continued flow of liquid such that the liquid level in the intermediate chamber is between a minimum level and a maximum level.

10. The method of claim 9, further comprising the step of: implementing a compensating conduit to compensate for a pressure difference between the gas space above the liquid in the liquid container and the gas space above the liquid in the intermediate chamber.

11. A method for controlling a liquid level of a liquid in an intermediate chamber, comprising the steps of:
supplying a liquid from a liquid container into the intermediate chamber;
opening a level valve when the liquid level in the intermediate chamber is lower than a set level;
closing the level valve when the liquid level in the intermediate chamber has exceeded a set level; and
compensating for a pressure difference between the gas space above the liquid in the liquid container and the gas space above the liquid in the intermediate chamber.

12. The method of claim 11, wherein the level valve comprises:
a float 20 floating on the liquid supplied to the intermediate chamber; and
a valve connected to the liquid container as to be able to control the supply of liquid from the liquid container into the intermediate chamber, wherein the valve is mechanically connected to the float such that the float closes the valve when the liquid level in the intermediate chamber has exceeded the maximum level, and the float opens the valve when the liquid level in the intermediate chamber is lower than the minimum level.

13. The method of claim 12, further comprising the steps of: defining the thickness of the liquid film in the trough with a lower end of a compensating pipe; situating the lower end of the compensating pipe underneath the bottom of the intermediate chamber and above the lower edge of the liquid outlet, situating the upper end of the compensating pipe above the upper edge of the liquid outlet.

14. The method of claim 13, further comprising the step of guiding the float with the compensating pipe, wherein the float comprises a recess through which the compensating pipe runs.

15. The method of claim 14, further comprising the step of flowing liquid out of the valve to the outside on the upper side of the float.
